(19) United States
(12) Patent Application Publication
(10) Pub. No.: US 2026/0237691 A1
(43) Pub. Date: Aug. 13, 2026

(54) FUEL CELL SYSTEM AND METHOD FOR OPERATING A FUEL CELL SYSTEM

(71) Applicant: Schaeffler Technologies AG & Co. KG, Herzogenaurach (DE)

(72) Inventors: Ralf HEISS, Warmensteinach (DE); Arno Bachstadt, Mohrendorf (DE); Martin Kohlmann, Grossenseebach (DE)

(73) Assignee: Schaeffler Technologies AG & Co. KG, Herzogenaurach (DE)

(21) Appl. No.: 19/154,272

(22) PCT Filed: Jan. 15, 2024
(86) PCT No.: PCT/DE2024/100036

§ 371 Date: Aug. 6, 2025

(30) Foreign Application Priority Data
Feb. 7, 2023 (DE) 10 2023 102 904.5

(51) Int. Cl. H01M 8/0202; H01M 8/0215; H01M 8/0228; H01M 8/04537; H01M 8/04955

(52) U.S. Cl. CPC H01M 8/0269; H01M 8/0215; H01M 8/0228; H01M 8/04552; H01M 8/04955; H01M 2250/10; H01M 2250/20

(57) ABSTRACT

A fuel cell system having a plurality of electrochemical cells that are separated from one another by at least one bipolar plate, wherein a voltage-measuring module comprising at least one circuit board is provided for cell voltage measurement. Here, the bipolar plate is formed as an integral, supporting element of the circuit board of the voltage-measuring module.

### CROSS-REFERENCE TO RELATED APPLICATIONS

This application is the U.S. National Phase of PCT Appln. No. PCT/DE 2024/100036, filed Jan. 15, 2024, which claims the benefit of German Patent Appln. No. 102023102904.5, filed Feb. 7, 2023, the entire disclosures of which are incorporated by reference herein.

### TECHNICAL FIELD

The disclosure relates to a fuel cell system constructed according to the preamble of claim 1, which comprises a plurality of electrochemical cells, i.e., fuel cells, arranged in a stack, wherein means for measuring the cell voltage are provided. The disclosure further relates to a method for operating such fuel cell systems.

### BACKGROUND

A generic fuel cell system is known for example from KR 102 212 446 B1.

The known fuel cell system comprises an electronic device coupled to a fuel cell stack. The electronic device comprises a circuit board connected to a connecting element and intended to enable voltage measurements.

WO 2012/115 510 A1 discloses an arrangement with an ion-permeable membrane designed for use in a fuel cell battery or a redox flow battery. The membrane extends beyond the cathode-side and anode-side spaces and is supported there by a support layer. There is also an integrated circuit on the support layer.

Overall, the device according to WO 2012/115 510 A1 should enable, among other things, voltage measurements, current measurements, conductivity measurements, humidity measurements, as well as pressure and temperature measurements.

A fuel cell stack described in CN 216 698 446 U comprises a plurality of bipolar plates and a measuring device. The measuring device is assigned to a printed circuit which is connected to a plug-in unit via copper foils. When developing the device according to CN 216 698 446 U, particular attention was paid to welding technology aspects.

A multichannel measuring device for a connection to a fuel cell stack is already known from DE 11 2007 001 409 B4. The multi-channel measuring device comprises a plurality of connection-side plugs, distinguishing between N-pole plugs and (N+1)-pole plugs.

An electronic monitoring device for fuel cells, which comprises a printed circuit board, is also known from KR 102 275 766 B1. This document also addresses the design of connecting elements.

DE 10 2013 113 948 A1 has the object of the selective response to the minimum cell voltage drop rate in a fuel cell system. It should be determined whether the voltage drop is the result of a depletion of cathode reactants or a depletion of anode reactants. In the event of a hydrogen depletion, DE 10 2013 113 948 A1 provides for a limitation of the power output of the fuel cell system. A generic fuel cell system is disclosed in CN 115 084 596 A.

### SUMMARY

The disclosure is based on the object of providing more advanced possibilities for cell voltage measurement in fuel cells compared to the cited prior art considering manufacturing and electrical engineering aspects.

According to the disclosure, this object is achieved by a fuel cell system having the features as set forth herein. The object is also achieved by a method for operating a fuel cell system as set forth herein.

In a known basic concept, the fuel cell system comprises a plurality of electrochemical cells, i.e., fuel cells, which are separated from one another by at least one bipolar plate, wherein a voltage-measuring module comprising at least one circuit board is provided for cell voltage measurement. The bipolar plate is designed as an integral, supporting element of the circuit board of the voltage-measuring module.

The disclosure is based on the consideration that it is in principle possible to transmit the currently applied voltage, which is generally dependent on time, from each cell of a stacked fuel cell system via a cable to a controller which is spatially separated from the cell and which is designed to further process the voltage information. In this conventional, unstressed manner, the voltage information reaches the controller with virtually no delay. The task of the control system can be, in particular, to make comparisons between digitized measured values and specified target or limit values.

The solution according to the application deliberately departs from this approach and shifts an essential part of the information processing on the bipolar plates. In particular, the digitization of the measured values, i.e., voltage measured values, already takes place on the individual bipolar plates. Because the bipolar plates themselves are designed as mechanically stable carriers of the circuits that carry out the analog-to-digital conversion and other digital processing steps, the entirety of the circuits attached to the bipolar plates can be integrated into the fuel cell stack in a space-saving and mechanically robust manner. An inherently stable design of the plate-shaped, electrically insulating layer of the circuit board, which is assigned to the voltage-measuring module, is not required. Compared to conventional, un-utilized solutions, which provide separate connections of numerous voltage-measuring devices to a central evaluation unit as well as a separate housing and fastening, a large part of the cabling effort is eliminated.

The further processed digital data output by the voltage-measuring module of the fuel cell system according to the application can be transmitted via a bus system of a known type to a control unit, which can be located anywhere inside or outside the fuel cell stack. A very small number of information inputs on the controller, for example just one or two, is sufficient. Compared to the transmission of analog data, corruption of information due to influences on the data transmission path is practically impossible. In addition, the data volume is drastically reduced compared to unprocessed measurement data.

According to the disclosure, the voltage measurement module comprises an ASIC (application-specific integrated circuit) or a plurality of ASICs. Regarding the use of ASICs in measurement systems, reference is made to documents EP 1 080 433 B1 and DE 10 2010 006 227 B4 by way of example. Data processing using ASICs in fuel cells is known in principle, for example from the documents US 2013/0341188 A1 and US 2015/0202621 A1. The last two documents concern analytical instruments.

The bipolar plate on which is built the circuit intended for cell voltage measurement, i.e., the voltage-measuring module, can be efficiently manufactured from metal, for example from sheet steel or titanium. In particular, the bipolar plate can be constructed from two superimposed, firmly connected, for example welded or soldered, half-plates which have an embossed structure. An electronic component with a metallic base plate and a ceramic circuit board is basically known, for example, from the document DE 11 2005 000 232 B4.

The voltage-measuring module of the fuel cell system according to the application comprises, in particular, an electrically non-conductive, for example ceramic, substrate which is designed as a coating of the bipolar plate. In a typical design, this substrate covers only a small part, usually less than 50%, of the section of the bipolar plate that is located outside the active field of the electrochemical cell.

Through the information processing carried out in the voltage measurement module, Boolean values, i.e., true-false information, can be obtained from analog values, i.e., voltage values. The statement as to whether a voltage measured on a cell is within a specified target range, above or below this range, has proven to be sufficient for further data processing in many applications. The amount of information is thus reduced to a minimum, while at the same time the susceptibility to errors of the further information transmission and processing is practically completely eliminated.

The method according to the application for operating a fuel cell system, which comprises a plurality of bipolar plates that separate the electrochemical cells from one another, generally provides that states of the electrochemical cells, i.e., fuel cells, are detected with the aid of voltage-measuring modules, each of which is constructed on a bipolar plate as a circuit carrier. A detected state is, in particular, an electrical voltage.

In addition, the measuring modules, which are generally referred to as voltage-measuring modules, can be designed to record at least one further variable, for example an electrical current, an electrical conductivity, a temperature, a chemical composition, and/or a pH value. In a typical design, the voltage-measuring modules do not transmit any analog values, but only logical information, i.e., Boolean values, to a higher-level data processing unit.

If the cell voltage detected on one of the electrochemical cells is too high, the operation of the fuel cell system can be automatically stopped. If, however, a cell voltage that is too low is detected on one of the electrochemical cells, the fuel cell system can be automatically switched to an emergency operating mode with reduced power. This serves in particular to protect a catalyst in a membrane of the electrochemical cell.

The fuel cell system is particularly suitable for use in a motor vehicle. The use of the fuel cell system in a stationary industrial plant is also considered.

### BRIEF DESCRIPTION OF THE DRAWINGS

In the following, an exemplary embodiment of the disclosure is explained in more detail with reference to drawings. In the figures:

FIG. 1 shows the structure of a fuel cell system in a block diagram,

FIG. 2 shows components of the fuel cell system according to FIG. 1 in a simplified sectional view,

FIG. 3 shows a flowchart of a method for operating the fuel cell system according to FIG. 1.

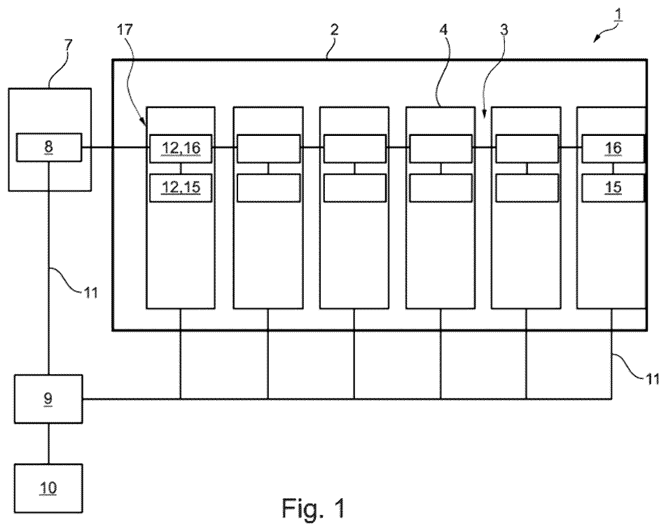

### DETAILED DESCRIPTION

A fuel cell system, identified overall by the reference symbol 1, comprises a cell stack 2, also referred to as a stack, which is constructed from a plurality of electrochemical cells 3, i.e., fuel cells, stacked on top of one another. In this case, a half-cell of a first electrochemical cell 3 is separated from a half-cell of a further electrochemical cell 3 by bipolar plates 4. The bipolar plates 4 are composed of half-plates 5, 6, with coolant channels 14 being formed between the half-plates 5, 6. With regard to the basic structure and function of the cell stack 2, reference is made to the prior art cited at the outset.

The entire cell stack 2 interacts with a control unit 7 (ECU-electronic control unit) in a manner described in more detail below. In the exemplary embodiment, a single processing unit 8, which is to be assigned to the control unit 7, is indicated. The control unit 7 is data-technically coupled to a linking module 9, to which all bipolar plates 4 are connected, as well as to a tank 10 for an operating medium of the fuel cell system 1. Electrical lines are uniformly designated with 11. The electrical lines 11 are to be assigned to a data bus of a type known in principle.

To measure the cell voltage present in the individual electrochemical cells 3, there is a voltage-measuring module 12 for each bipolar plate 4. The voltage-measuring module 12 is located directly on one of the half-plates 5, 6 and is permanently connected to the corresponding half-plate 5, 6. Here, a ceramic substrate 13 of the voltage-measuring module 12 is applied to the half-plate 5, 6 in the form of a coating. A surface section of the bipolar plate 4, together with the ceramic substrate 13 located thereon, is part of a printed circuit board designated overall by 17. The majority of the total surface of the bipolar plate 4 is free of any ceramic coating.

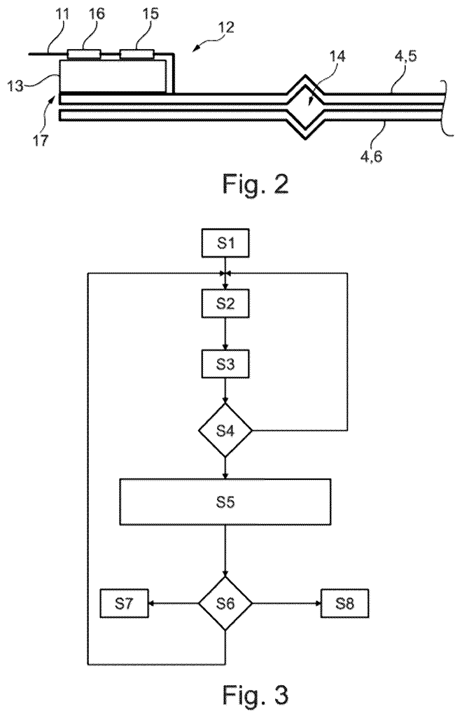

A detection module 15 and an analysis module 16 are also assigned to the voltage-measuring module 12. The detection module 15 is used to acquire analog voltage measurement values, i.e., cell voltage measurement in the narrower sense. In analysis module 16, these values are digitized and further processed. The modules 15, 16 mentioned are not necessarily physically separated from one another, as shown schematically in FIG. 2. Rather, the functions of modules 15, 16 can be realized by a single ASIC. Likewise, several electronic components can be provided to carry out the various acquisition and analysis functions, which are designed as ASICs in only one case or only in some of several cases.

Regarding the operation of the fuel cell system 1, reference is made to the flow chart shown in FIG. 3. S1 here represents the start of the intended operation of the fuel cell system 1. In step S2, the electrical voltage applied to the fuel cell 3 is measured with the aid of the detection module 15. In the following step S3, the digitized voltage measurement value is compared with a target value range using the analysis module 16. The result of this comparison is the information as to whether the target value range is maintained or whether the specified upper or lower limit value is exceeded or undershot. Only this logical information is transmitted to the central control unit 7 via the line 11, i.e., via the bus system. However, voltage values are not transmitted to the control unit 7. In other words: Only Boolean values are transmitted from the voltage-measuring module 12 to the control unit 7. In step S4, a query is made as to whether the transmission has already been completed for all voltage-measuring modules 12. Unlike the simplified representation in FIG. 3, parallel detection and transmission of data can also be provided.

In step S5, the information of all voltage-measuring modules 12 regarding compliance with specified ranges of the cell voltage of the individual electrochemical cells 3 is available. The control unit 7 generates therefrom a compressed information which indicates whether the specified voltage range is maintained in the entire fuel cell system 1 or whether an exceeding or undershooting of the limit value has been detected in at least one electrochemical cell 3. A check in this regard takes place in step S6. If the limit value is undershot, the operation of the fuel cell system 1 is switched to restricted operation, i.e., emergency operation, in step S7. If, however, the specified maximum voltage value is exceeded, the fuel cell system 1 is completely shut down in step S8. As long as the measured cell voltages remain within the target range and no stop signal is given, the operating procedure continues as illustrated in FIG. 3.

LIST OF REFERENCE SYMBOLS
1 Fuel cell system
2 Cell stack
3 Fuel cell, electrochemical cell
4 Bipolar plate
5 Half-plate
6 Half-plate
7 Control unit, ECU
8 Processing unit
9 Linking module
10 Tank
11 Electrical line
12 Voltage-measuring module
13 Ceramic substrate
14 Coolant channel
15 Detection module
16 Analysis module
17 Circuit board
S1 . . . S8 Method steps

1. A fuel cell system comprising:
a plurality of electrochemical cells which are separated from one another by at least one bipolar plate, and
a voltage-measuring module having at least one printed circuit board being provided for cell voltage measurement,
wherein the bipolar plate is designed as an integral, supporting element of the circuit board of the voltage-measuring module and the voltage-measuring module comprises an ASIC.

2. The fuel cell system according to claim 1, wherein the voltage-measuring module comprises a substrate designed as an electrically non-conductive coating of the bipolar plate.

3. The fuel cell system according to claim 1, wherein the voltage-measuring module is designed to convert a measured value into a Boolean value.

4. The fuel cell system according to claim 1, wherein a plurality of voltage-measuring modules are integrated into a bus system.

5. A method for operating a fuel cell system comprising:
providing a fuel cell system having a plurality of bipolar plates separating the electrochemical cells from one another, wherein states of the electrochemical cells are detected by means of voltage-measuring modules which are each constructed on a bipolar plate as a circuit carrier,
obtaining logical information with each voltage-measuring module based on voltage measurement values and only these are forwarded.

6. The method according to claim 5, wherein the logical information describes whether a voltage measured on a cell is within a specified target range, above or below this range.

7. The method according to claim 5, wherein in the event of an excessively high cell voltage detected at one of the electrochemical cells, the operation of the fuel cell system is automatically stopped.

8. The method according to claim 5, wherein in the event of a cell voltage detected at one of the electrochemical cells being too low, the operation of the fuel cell system is automatically switched to an emergency operating mode.

9. The fuel cell system according to claim 1, wherein the coating includes a ceramic coating.

10. The fuel cell system according to claim 2, wherein the voltage-measuring module is designed to convert a measured value into a Boolean value.

11. The fuel cell system according to claim 2, wherein a plurality of voltage-measuring modules are integrated into a bus system.

12. The fuel cell system according to claim 3, wherein a plurality of voltage-measuring modules are integrated into a bus system.

13. The method according to claim 6, wherein in the event of an excessively high cell voltage detected at one of the electrochemical cells, the operation of the fuel cell system is automatically stopped.

14. The method according to claim 6, wherein the voltage measuring module of a bipolar plate is connected to a further voltage measuring module of a further bipolar plate, and wherein a processor is connected to only one of the voltage measuring modules.

15. The fuel cell system according to claim 4, wherein the voltage measuring module of a bipolar plate is connected to a further voltage measuring module of a further bipolar plate, and wherein a processor is connected to only one of the voltage measuring modules.

16. A fuel cell system comprising:
a plurality of electrochemical cells which are separated from one another by at least one bipolar plate, and
a voltage-measuring module having at least one printed circuit board being provided for cell voltage measurement,
wherein the bipolar plate is designed as an integral, supporting element of the circuit board of the voltage-measuring module and the voltage-measuring module comprises an ASIC, and
wherein the module transmits voltage data in the form of Boolean values to an external control unit.

17. The fuel cell system according to claim 16, wherein the Boolean values describe whether a voltage measured on a cell is within a specified target range, above or below this range.

18. The fuel cell system according to claim 16, wherein the voltage-measuring module comprises a substrate designed as an electrically non-conductive coating of the bipolar plate.

19. The fuel cell system according to claim 18, wherein the coating includes a ceramic coating.

20. The fuel cell system according to claim 18, wherein a plurality of voltage-measuring modules are integrated into a bus system.
